(19) United States
(12) Patent Application Publication
(10) Pub. No.: US 2006/0004903 A1
(43) Pub. Date: Jan. 5, 2006

(54) CSA tree constellation

(76) Inventor: Itay Admon, Tel Aviv (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/879,529

(22) Filed: Jun. 30, 2004

(51) Int. Cl. G06F 17/10

(52) U.S. Cl. 708/708

(57) ABSTRACT

Embodiments of the present invention provide a method, apparatus and system for selectively switching between at least first and second configurations of a carry-save-adder bit slice corresponding to at least first and second respective modes of operation of the bit slice. Other embodiments are described and claimed.

### BACKGROUND OF THE INVENTION

A conventional multiplier may include circuitry for producing a set of Partial Products (PPs) corresponding to an input multiplier operand and an input multiplicand operand. The multiplier may also include a Carry-Save-Adder (CSA) tree constellation for reducing the set of PPs to produce an output corresponding to the product of the input multiplier and multiplicand operands. The multiplier may be designed to support a multiplication of a multiplier operand having a data size smaller or equal to a predetermined multiplier data size l, and a multiplicand operand having a data size smaller than or equal to a predetermined multiplicand data size k. The capacity of such multiplier may be defined as (l bits)*(k bits).

It may be desired to implement such a multiplier for simultaneously performing two or more multiplications of two or more multiplier and multiplicand operands having a relatively small data size, for example, by concatenating the two or more multiplier and/or multiplicand operands. However, such implementation may require separating the concatenated multiplicand operands from one another by a plurality of “spacer” bits, e.g., in order to prevent overlapping between the one or more bit slices of the CSA tree constellation corresponding to the two or more multiplications. For example, at least fourteen spacer bits may be required to separate between two 16-bit multiplicand operands.

Thus, a conventional multiplier for performing a multiplication of two n-bit multiplier operands and two n-bit multiplicand operands may have a capacity higher than (2n bits)*(n bits), e.g., a capacity of (3n bits)*(n bits).

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic illustration of a computing platform including a dual mode multiplier according to some exemplary embodiments of the present invention;

FIG. 2 is a schematic illustration of a dual mode multiplier in accordance with some exemplary embodiments of the invention;

FIG. 3 is a schematic flow diagram of the multiplier of FIG. 2 in a first mode of operation, according to some exemplary embodiments of the invention;

FIG. 4 is a schematic flow diagram of the multiplier of FIG. 2 in a second mode of operation, according to some exemplary embodiments of the invention;

FIG. 5 is a schematic, conceptual illustration helpful in understanding the operation of a dual mode carry save adder according to some exemplary embodiments of the invention;

FIG. 6 is a schematic illustration of a switchable bit slice according to an exemplary embodiment of the invention;

FIGS. 7-11 are schematic illustrations of five switchable bit slices, respectively, according to other exemplary embodiments of the invention; and

FIG. 12 is a schematic illustration of a flow chart of a method of switching between bit slice configurations according to some exemplary embodiments of the invention.

It will be appreciated that for simplicity and clarity of illustration, elements shown in the drawings have not necessarily been drawn accurately or to scale. For example, the dimensions of some of the elements may be exaggerated relative to other elements for clarity or several physical components included in one functional block or element. Further, where considered appropriate, reference numerals may be repeated among the drawings to indicate corresponding or analogous elements. Moreover, some of the blocks depicted in the drawings may be combined into a single function.

### DETAILED DESCRIPTION OF EMBODIMENTS OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits may not have been described in detail so as not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

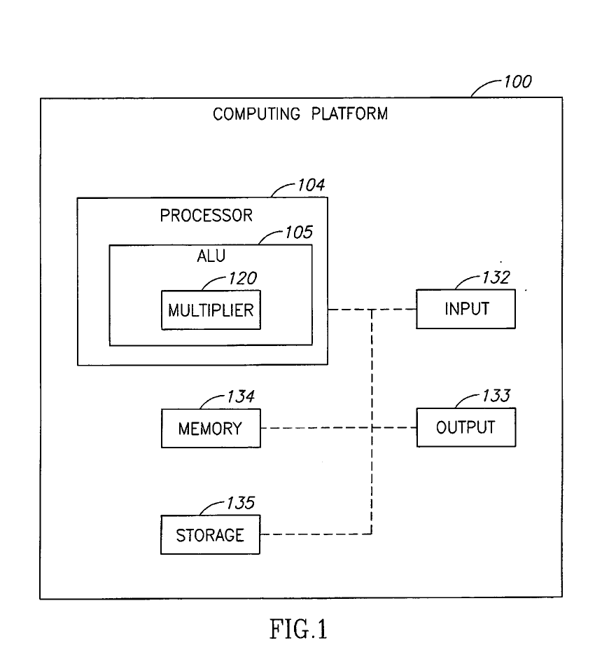

Reference is made to FIG. 1, which schematically illustrates a computing platform 100 according to some exemplary embodiments of the present invention.

According to some exemplary embodiments, platform 100 may include a processor 104. Processor 104 may include, for example, a Central Processing Unit (CPU), a Digital Signal Processor (DSP), a microprocessor, a host processor, a plurality of processors, a controller, a chip, a microchip, or any other suitable multi-purpose or specific processor or controller.

According to some exemplary embodiments of the invention, processor 104 may include one or more Arithmetic Logic Units (ALUs) 105. One or more of ALUs 105 may include at least one dual mode multiplier 120 able to selectively perform a multiplication of a multiplier operand and a multiplicand operand, or two or more multiplications of two or more multiplier operands and two or more multiplicand operands, respectively, as described in detail below. For example, multiplier 120 may be able to selectively perform a multiplication of an n-bit multiplier operand and a 2n-bit multiplicand operand, or two multiplications of two n-bit multiplier operands and two n-bit multiplicand operands, respectively.

According to some exemplary embodiments of the invention, platform 100 may also include an input unit 132, an output unit 133, a memory unit 134, and/or a storage unit 135. Platform 100 may additionally include other suitable hardware components and/or software components. In some embodiments, platform 100 may include or may be, for example, a computing platform, e.g., a personal computer, a desktop computer, a mobile computer, a laptop computer, a notebook computer, a terminal, a workstation, a server computer, a Personal Digital Assistant (PDA) device, a tablet computer, a network device, a micro-controller, a cellular phone, a camera, or any other suitable computing and/or communication device.

Input unit 132 may include, for example, a keyboard, a mouse, a touch-pad, or other suitable pointing device or input device. Output unit 133 may include, for example, a Cathode Ray Tube (CRT) monitor, a Liquid Crystal Display (LCD) monitor, or other suitable monitor or display unit.

Storage unit 135 may include, for example, a hard disk drive, a floppy disk drive, a Compact Disk (CD) drive, a CD-Recordable (CD-R) drive, or other suitable removable and/or fixed storage unit.

Memory unit 134 may include, for example, a Random Access Memory (RAM), a Read Only Memory (ROM), a Dynamic RAM (DRAM), a Synchronous DRAM (SD-RAM), a Flash memory, a volatile memory, a non-volatile memory, a cache memory, a buffer, a short term memory unit, a long term memory unit, or other suitable memory units or storage units.

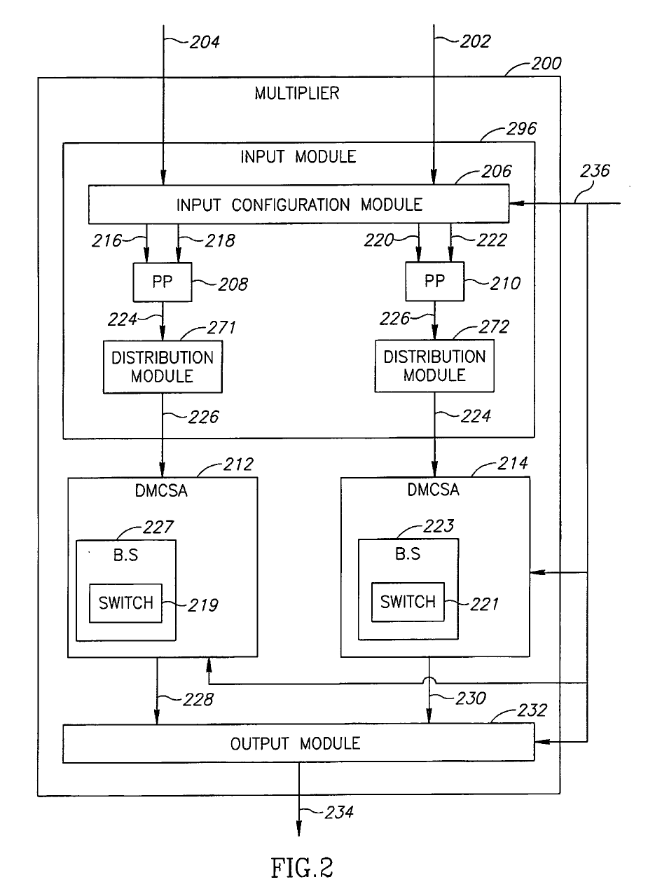

Reference is now made to FIG. 2, which schematically illustrates a dual mode multiplier 200 in accordance with some exemplary embodiments of the invention. Multiplier 200 may be used with any suitable processor configuration, as is known in the art. For example, multiplier 200 may be implemented as part of an ALU and/or any other hardware element or circuit to perform the multiplication functionality according to the invention. Although the invention is not limited in this respect, multiplier 200 may be used to perform the functionality of multiplier 105 of FIG. 1. In some embodiments, multiplier 200 may be implemented, for example, for performing one or more multiplication operations related to the MMX instruction set, the MMX2 instruction set, the SSE instruction set, the SSE2 instruction set, and/or any other suitable multiplication operation.

According to some exemplary embodiments of the invention, multiplier 200 may be able to receive a first input signal 202, e.g., including one or more multiplier operands, and a second input signal 204, e.g., including one or more multiplicand operands, and to produce an output signal 234 including one or more products of the one or more multiplier and multiplicand operands, as described below. Signals 202 and 204 may be received, for example, from one or more register files (not shown), as are known in the art.

According to exemplary embodiments of the invention, multiplier 200 may operate at either a first mode of operation, e.g., corresponding to a first type of input signals 202 and 204, or a second mode of operation, e.g., corresponding to a second type of input signals 202 and 204, as described below. The mode of operation of multiplier 200 may be controlled, for example, by a control signal 236, e.g., provided by an instruction decoder (not shown) or by one or more elements of ALU 105 (FIG. 1), as is known in the art.

According to exemplary embodiments of the invention, multiplier 200 may include an input module 296 able to receive signals 202 and 204 and to produce at least one set of Partial Products (PP), e.g., PP set 224 and PP set 226, corresponding to one or more products of one or more of the multiplier and multiplicand operands of signals 202 and 204. Input module 296 may include any suitable hardware and/or circuitry, e.g., including one or more multipliexers as are known in the art, for producing PP set 224 and/or PP set 226 corresponding to the mode of operation of multiplier 200, e.g., as described below.

According to some exemplary embodiments of the invention, input module 296 may include an input configuration module 206 able to receive signals 202 and 204 and to produce one or more signals, e.g., signals 216, 218, 220 and/or 222, including one or more of the multiplier and/or multiplicand operands of signals 202 and 204, as described in detail below. Module 206 may include any suitable hardware and/or circuitry, for example, including one or more multiplexers as are known in the art, capable of providing output signals 216, 218, 220, and/or 222 corresponding to the mode of operation of multiplier 200, e.g., as determined by signal 236.

According to exemplary embodiments of the invention, module 296 may also include a first PP module 210 able to produce PP set 226 corresponding to signals 222 and 220, and a second PP module able to produce PP set 224 corresponding to signals 218 and 216. PP modules 208 and/or 210 may include any suitable hardware and/or circuitry for producing PP sets 224 and 226, e.g., using any suitable algorithm known in the art, for example, a Booth encoding algorithm as is known in the art. The number and/or size of the PPs of set 224 and/or set 226 may depend on the radix of the Booth encoding algorithm used by modules 208 and/or 210, and/or on the bit-size of the multiplicand operands, as described in detail below.

According to exemplary embodiments of the invention, multiplier 200 may also include at least one Dual Mode Carry-Save-Adder (DMCSA) tree constellation having two modes of operation corresponding to the two modes of operation of multiplier 200, e.g., as described below. For example, multiplier 200 may include a first DMCSA tree constellation 212 and a second DMCSA tree constellation 214. DMCSA 212 may include at least one switchable bit slice 227 associated with at least one switch 219 capable of selectively switching between first and second configurations of bit slice 227 corresponding to the mode of operation of DMCSA 212, as described below. DMCSA 214 may include at least one switchable bit slice 223 associated with at least one switch 221 capable of selectively switching between first and second configurations of bit slice 223 corresponding to the mode of operation of DMCSA 214. DMCSAs 212 and 214 may be able to receive PP sets 226 and 224, respectively, to assimilate (“reduce”) at least part of the received PP set, and to produce outputs 228 and 230, respectively, corresponding to the mode of operation of multiplier 200, as described in detail below.

According to some exemplary embodiments of the invention, module 296 may also include one or more bit-distribution modules, e.g., including one or more multiplexers as are known in the art, for directing one or more bits of the output of one or more of the PP modules to one or more bit slices of a respective DMCSA corresponding to the mode of operation of multiplier 200. For example, module 296 may include first and second bit-distribution modules 271 and 272. Module 272 may be adapted to direct a certain bit output of PP 210 to one input of a certain bit slice of DMCSA 214 in the first mode of operation, and to direct the certain bit output to another input of the certain bit slice in the second mode of operation, e.g., as described below. Accordingly, module 271 may be adapted to direct a certain bit output of PP 208 to one input of a certain bit slice of DMCSA 212 in the first mode of operation, and to direct the certain bit output to another input of the certain bit slice in the second mode of operation.

According to exemplary embodiments of the invention, multiplier 200 may also include an output module 232 able to receive output 230 and/or output 228 and produce output 234 corresponding to the mode of operation of multiplier 200, e.g., as described below.

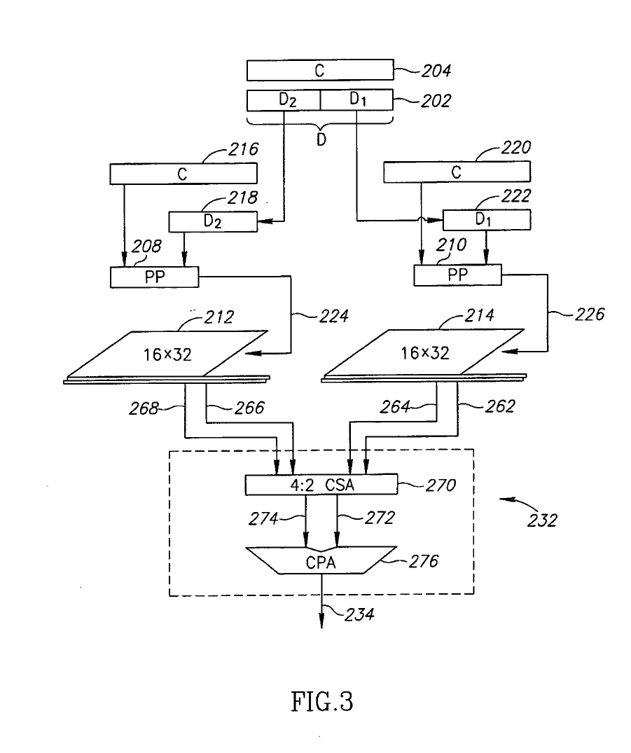

Reference is made to FIG. 3, which schematically illustrates a flow diagram of multiplier 200 in the first mode of operation, according to some exemplary embodiments of the invention.

As illustrated in FIG. 3, in the first mode of operation, multiplier 200 may be able to receive signal 202 including a 2n-bit multiplier, denoted D, and signal 204 including a 2n-bit multiplicand operand, denoted C, and to produce output 234 corresponding to a 4n-bit product, e.g., D*C, of the 2n-bit multiplier and the 2n-bit multiplicand operand of signals 202 and 204, respectively, wherein n is a predetermined integer, e.g., n=16.

As illustrated in FIG. 3, module 206 may be able to produce signal 222 including the n Least Significant Bits (LSBs), denoted D₁, of signal 202, signal 220 including C, signal 218 including the n Most Significant Bits (MSBs), denoted D₂, of signal 202, and signal 216 including C.

According to the exemplary embodiments illustrated in FIG. 3, module 208 and 210 may use a radix 4 Booth encoding algorithm, as is known in the art, and n may equal 16. Accordingly, PP set 226 may include nine 32-bit PPs corresponding to a product of 16-bit signal 222 and 32-bit signal 220, and set 224 may include nine 32-bit PPs corresponding to a product of 16-bit signal 218 and 32-bit signal 216.

As illustrated in FIG. 3, the first configuration of DMCSA 214 may be capable of reducing the nine 32-bit PPs of set 226, to produce an output, for example, a 48-bit output, e.g., including a “sum” signal 262 and a “carry” signal 264, as described in detail below. Accordingly, the first configuration of DMCSA 212 may be capable of reducing the nine 32-bit PPs of set 224, to produce an output, for example, a 48-bit output, e.g., including a “sum” signal 266 and a “carry” signal 268.

Thus, according to some exemplary embodiments of the invention, signals 262 and 264 may have values corresponding to the product D1*C and signals 266 and 268 may have values corresponding to the product D2*C.

As illustrated in FIG. 3, output module 232 may be adapted to combine signals 262, 264, 266 and 268 to produce output 234. For example, module 232 may include a 4:2 CSA 270 and a 64-bit Carry Propagate Adder (CPA) 276, as are known in the art. CSA 270 may receive signals 262, 264, 266 and 268 and produce a “sum” signal 272 and a “carry” signal 274 having values corresponding to a sum of signals 262, 264, 266 and 268, e.g., as is known in the art. CPA 276 may combine signals 272 and 274 to produce 64-bit output 234. Thus, output 234 may include a 64-bit signal having a value corresponding to the product D*C.

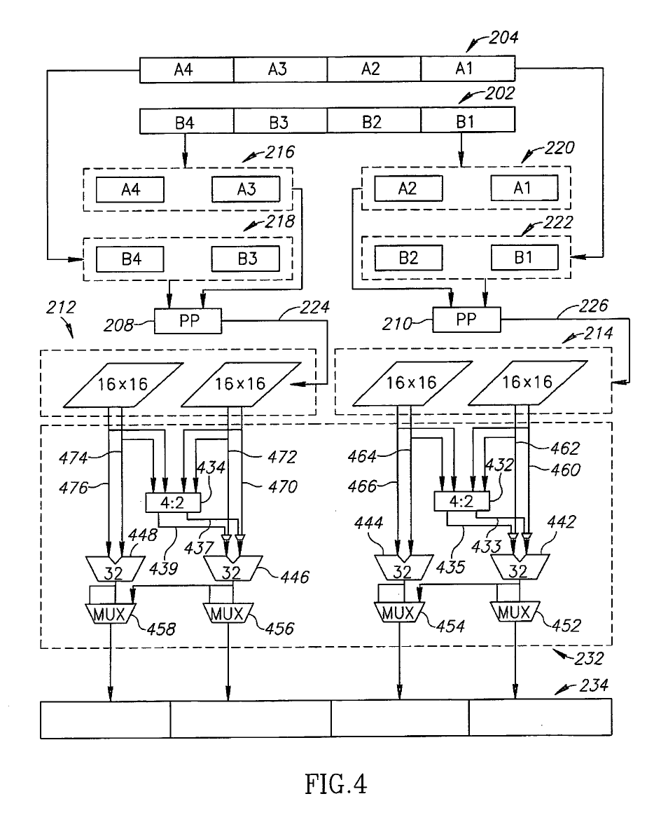

Reference is also made to FIG. 4, which schematically illustrates a flow diagram of multiplier 200 in the second mode of operation, according to some exemplary embodiments of the invention.

As illustrated in FIG. 4, in the second mode of operation, multiplier 200 may be able to receive signal 202 including first, second third and fourth n-bit multiplier operands, denoted, B1, B2, B3 and B4, respectively, and signal 204 including first, second, third and fourth n-bit multiplicand operands, denoted, A1, A2, A3 and A4, respectively. Multiplier 200 may be able to produce output 234 related to the products B1*A1, B2*A2, B3*A3, and B4*A4. For example, output 234 may include four n-bit LSBs and/or MSBs of the products B1*A1, B2*A2, B3*A3, and B4*A4. Additionally or alternatively, output 234 may include any other desired combination of part/all of one or more of the products B1*A1, B2*A2, B3*A3, and B4*A4, e.g., including B1*A1+B2*A2 and/or B3*A3+B4*A4, or the n-bit LSBs or MSBs thereof, as described below. For example, in the second mode of operation, signal 202 may include four 16-bit multiplier operands and signal 204 may include four 16-bit multiplicand operands, and multiplier 200 may produce output 234 including four, e.g., 32-bit or 16-bit, product operands corresponding to the products of the four multiplier and multiplicand operands, respectively.

As illustrated in FIG. 4, module 206 may be able to produce signal 222 including the first two n-bit multiplier operands, e.g., B1 and B2, of signal 202, signal 220 including the first two n-bit multiplicand operands, e.g., A1 and A2, of signal 204, signal 218 including the second two n-bit multiplier operands, e.g., B3 and B4, of signal 202, and signal 216 including the second two n-bit multiplicand operands, e.g., A3 and A4, of signal 204.

According to the exemplary embodiments illustrated in FIG. 4, modules 208 and 210 may use a radix 4 Booth encoding algorithm, as is known in the art, and n may equal 16. Accordingly, PP set 226 may include nine 32-bit PPs and set 224 may include nine 32-bit PPs, e.g., wherein the 16 LSBs of the PPs of sets 226 and 224 are related to the products B1*A1 and B3*A3, respectively, and the 16 MSBs of the PPs of sets 226 and 224 are related to the product of B2*A2, and B4*A4, respectively.

As illustrated in FIG. 4, the second configuration of DMCSA 214 may be capable of separately reducing the 16 LSBs of the PPs of set 226 and the 16 MSBs of the PPs of set 226, and the second configuration of DMCSA 212 may be capable of separately reducing the 16 LSBs of the PPs of set 224 and the 16 MSBs of the PPs of set 224, e.g., as described below. The second configuration of DMCSA 214 may produce a first sum signal 460 and a first “carry” signal 462 related to the product B1*A1, and a second sum signal 464 and a second “carry” signal 466 related to the product B2*A2. The second configuration of DMCSA 212 may produce a third sum signal 470 and a third “carry” signal 472 related to the product B3*A3, and a fourth sum signal 474 and a fourth “carry” signal 476 related to the product B4*A4.

As illustrated in FIG. 4, output module 232 may be adapted to combine at least some of signals 460, 462, 464, 466, 470, 472, 474 and 476. For example, according to some embodiments, module 232 may include a first 32-bit Full Adder (FA) 442 to receive signals 460 and 462; a second 32-bit FA 444 to receive signals 464 and 466; a third 32-bit FA 446 to receive signals 470 and 472; and a fourth 32-bit FA 448 to receive signals 474 and 476. Module 232 may also include first, second, third and fourth multiplexers 452, 454, 456 and 458 able to selectively provide the 16 LSBs and/or 16 MSBs of the outputs of FAs 442, 444, 446 and 448, respectively. According to some exemplary embodiments, module 232 may also include a first 4:2 CSA 432 to receive signals 460, 462, 464 and 466 and provide FA 442 with two signals 433 and 435 related to the sum B1*A1+B2*A2, as is known in the art. Additionally or alternatively, module 232 may include a second 4:2 CSA 434 to receive signals 470, 472, 474 and 476 and provide FA 446 with two signals 437 and 439 related to the sum B3*A3+B4*A4, as is known in the art. Module 232 may additionally or alternatively include any other suitable hardware and/or circuitry, e.g., as known in the art, for performing any desired operation on signals 460, 462, 464, 466, 470, 472, 474 and/or 476.

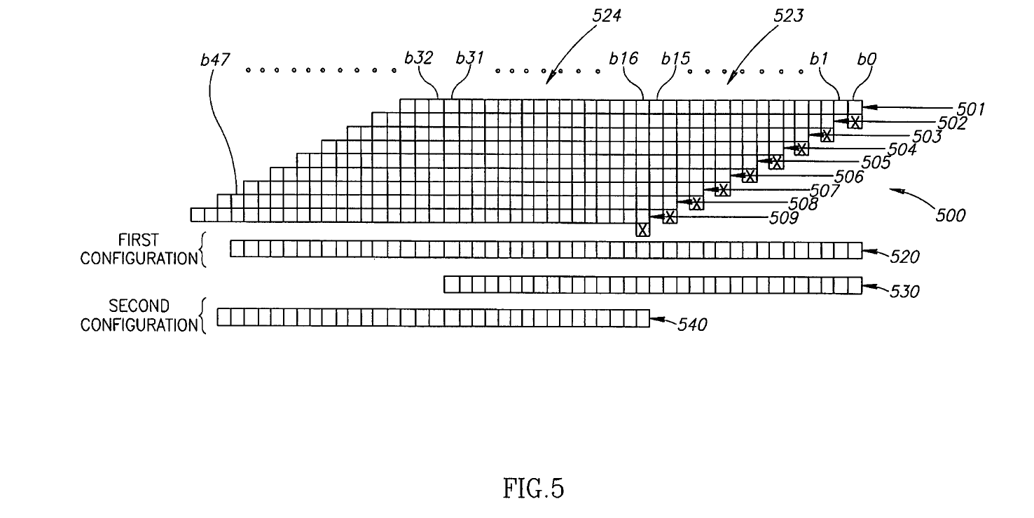

Reference is made to FIG. 5, which is a schematic, conceptual illustration helpful in understanding the operation of a DMCSA 500 according to some exemplary embodiments of the invention. DMCSA 500 may be used with any suitable configuration, as is known in the art. For example, DMCSA 500 may be implemented as part of a multiplier and/or any other hardware element or circuit to perform the carry-save-add functionality according to the invention. Although the invention is not limited in this respect, DMCSA 500 may be used to perform the functionality of DMCSA 212 and/or DMCSA 214 of FIG. 2.

According to exemplary embodiments of the invention, DMCSA 500 may receive a set of PPs, e.g., including nine 32-bit PPs 501-509 each being shifted two bits from a preceding PP as known in the art. DMCSA 500 may also be able to produce either an output 520, e.g., in a first mode of operation, or two outputs 530 and 540, e.g., in a second mode of operation. DMCSA 500 may include a plurality of bit slices, e.g., 48 bit slices denoted b0-b47. Bit slices b0-b47 may be adapted to produce respective bits of output 520, e.g., in the first mode of operation, or of outputs 530 and 540, e.g., in the second mode of operation, corresponding to a sum of one or more bits of PPs 501-509, as described below.

According to some exemplary embodiments of the invention, bit slices b0 and b may respectively associate the first and second LSBs of PP 501 with the first and second LSBs of the output of DMCSA 500, e.g. output 520 in the first mode of operation, or output 530 in the second mode of operation. Bit slices b2 and b3 may each include a half-adder for adding two bits of PPs 501 and 502; bit slices b4 and b5 may each include a 3:2 reduction arrangement, e.g., for reducing three bits of PPs 501-503; bit slices b6 and b7 may include a 4:2 reduction arrangement, e.g., for reducing four bits of PPs 501-504; bit slices b8 and b9 may include a 5:2 reduction arrangement, e.g., for reducing five bits of PPs 501-505; bit slices b10 and b11 may include a 6:2 reduction arrangement, e.g., for reducing six bits of PPs 501-506; bit slices b12 and b13 may include a 7:2 reduction arrangement, e.g., for reducing seven bits of PPs 501-507; bit slices b14 and b15 may include a 8:2 reduction arrangement, e.g., for reducing eight bits of PPs 501-508; bit slices b32 and b33 may include a 8:2 reduction arrangement, e.g., for reducing eight bits of PPs 502-509; bit slices b34 and b35 may include a 7:2 reduction arrangement, e.g., for reducing seven bits of PPs 503-509; bit slices b36 and b37 may include a 6:2 reduction arrangement, e.g., for reducing six bits of PPs 504-509; bit slices b38 and b39 may include a 5:2 reduction arrangement, e.g., for reducing five bits of PPs 505-509; bit slices b40 and b41 may include a 4:2 reduction arrangement for reducing four bits of PPs 506-509; bit slices b42 and b43 may include a 3:2 reduction arrangement, e.g., for reducing three bits of PPs 507-509; bit slices b44 and b45 may include a full-adder for adding two bits of PPs 508-509; and/or bit slices b46 and b47 may associate the first and second MSBs of PP 509 with the first and second MSBs of output 520 or output 540, respectively. One or more of the reduction arrangements may include one or more CSA's and/or adders as are known in the art.

According to exemplary embodiments of the invention, in the second mode of operation, bit slices b16-b31 may include two separate CSA trees 523 and 524. Tree 523 may be adapted, for example, to reduce bits 16-17 of PP 502, bits 16-19 of PP 503, bits 16-21 of PP 504, bits 16-23 of PP 505, bits 16-25 of PP 506, bits 16-27 of PP 507, bits 16-29 of PP 508 and bits 16-31 of PP 509, e.g., to produce the 16 MSBs of output 530. Tree 524 may be adapted, for example, to reduce bits 16-31 of PP 501, bits 20-31 of PP 502, bits 22-31 of PP 503, bits 24-31 of PP 504, bits 26-31 of PP 505, bits 28-31 of PP 506, bits 28-31 of PP 507 and bits 30-31 of PP 508, e.g., to produce the 16 LSBs of output 540, as described below.

According to exemplary embodiments of the invention at least some of bit slices b16-b31 may include a switchable bit slice able to be selectively switched between at least first and second configurations, as described below. For example, bit slices b16, b17, b30 and b31 may include a 9:2/(1:1+8:1) switchable bit slice able to be switched between a first configuration including a 9:2 reduction arrangement, e.g., for reducing nine bits of PPs 501-509, and a second configuration including separate 1:1 and 8:1 reduction arrangements. For example, at the second configuration bit slice b16 may separately associate the seventeenth bit of PP 501 with the LSB of output 540 and reduce eight bits of PPs 502-509 to produce the seventeenth bit of output 530. Bit slices b18, b19, b28 and b29 may include a 9:2/(2:1+7:2) bit slice, e.g., able to be switched between a first configuration including a 9:2 reduction arrangement, and a second configuration including separate 2:1 and 7:2 reduction arrangements. For example, at the second configuration bit slice b18 may separately reduce seven bits of PPs 503-509 to produce the eighteenth bit of output 530 and reduce two bits of PPs 501-502 to produce the second bit of output 540. Bit slices b20, b21, b26 and b27 may include a 9:2/(3:2+6:2) bit slice, e.g., able to be switched between a first configuration including a 9:2 reduction arrangement and a second configuration including separate 3:2 and 6:2 reduction arrangements. For example, at the second configuration bit slice b20 may separately reduce six bits of PPs 504-509 to produce the nineteenth bit of output 530 and reduce three bits of PPs 501-503 to produce the fifth bit of output 540. Bit slices b22, b23, b24 and b25 may include a 9:2/(4:2+5:2) bit slice, e.g., able to be switched between a first configuration including a 9:2 reduction arrangement and a second configuration including separate 4:2 and 5:2 reduction arrangements. For example, at the second configuration bit slice b22 may separately reduce five bits of PPs 505-509 to produce the twenty first bit of output 530 and reduce four bits of PPs 501-504 to produce the seventh bit of output 540.

Thus, according to exemplary embodiments of the invention, in the first mode of operation, DMCSA 500 may be capable of reducing nine 32-bit PPs 501-509, into output 520, e.g., including 48 bits, corresponding to a product of a 16-bit multiplier operand and a 32-bit multiplicand operand. In the second mode of operation, DMCSA 500 may be capable of reducing 16 LSBs of nine 32-bit PPs 501-509 into output 530, e.g., including 32 bits, and reducing 16 MSBs of PPs 501-509 into output 540, e.g., including 32-bits, corresponding to two products of two 16-bit multiplier operands and two 16-bit multiplicand operands, respectively.

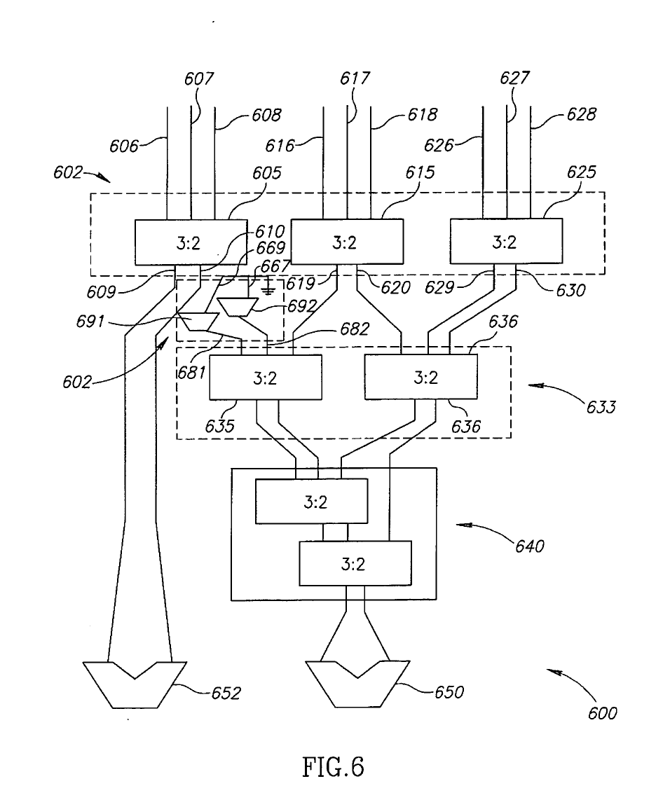

Reference is made to FIG. 6, which schematically illustrates a switchable 9:2/(6:2+3:2) bit slice 600 according to exemplary embodiments of the invention.

According to exemplary embodiments of the invention, bit slice 600 may include a first CSA stage 602 including a first 3:2 CSA 605 having three inputs 606, 607 and 608, and two outputs 609 and 610, a second 3:2 CSA 615 having three inputs 616, 617 and 618, and two outputs 619 and 620, and a third 3:2 CSA 625 having three inputs 626, 627, and 628 and two outputs 629 and 630. Bit slice 600 may also include a second CSA stage 633 including fourth and fifth 3:2 CSAs 635 and 636, a third CSA stage including a 4:2 CSA 640, a first FA 650 and a second FA 652, as are known in the art.

According to some exemplary embodiments of the invention, bit slice 600 may also include at least one switch 602 for selectively switching between at least two configurations of bit slice 600, as described below.

According to exemplary embodiments of the invention, switch 602 may be able to selectably associate outputs 609 and 610 with two inputs 681 and 682 of CSA 635, respectively, e.g., corresponding to the first configuration of bit slice 600, and/or with two inputs of FA 652, e.g., corresponding to the second configuration of bit slice 600.

Thus, according to exemplary embodiments of the invention, the first configuration of bit slice 600 may include a 9:2 reduction arrangement, e.g., including CSAs 605, 615, 625, 635, 636, and 640 and FA 650 capable of reducing nine PP bits, e.g., received via inputs 606-608, 616-618 and 626-628. The second configuration of bit slice 600 may include a 6:2 reduction arrangement, e.g., including CSAs 615, 625, 635, 636, and 640 and FA 650 capable of reducing six PP bits, e.g., received via inputs 616-618 and 626-628; and a 3:2 reduction arrangement, e.g., including CSA 605 and FA 652 capable of reducing three PP bits, e.g., received via inputs 706-708.

According to exemplary embodiments of the invention, switch 602 may include any suitable hardware and/or circuitry for selectably switching between the first and second configurations of bit slice 600, e.g., corresponding the value of a control signal, e.g., control signal 236 (FIG. 2). For example, switch 602 may include a first multiplexer 691 having a first input associated with output 609, a second input 669, e.g., receiving a zero value, and an output associated with input 681. Switch 602 may also include a second multiplexer 692 having a first input associated with output 610, a second input 667, e.g., receiving a zero value, and an output associated with input 682.

According to some exemplary embodiments of the invention, one or two additional PPs may be provided to inputs 669 and 667, respectively, e.g., instead of one or both of the zero values. Accordingly, the second configuration of bit slice 600 may be used for separately reducing a first set of seven or eight PPs, e.g., of inputs 616-618, 626-628, 667 and/or 669, and a second set of 3 PPs, e.g., of inputs 606-608.

According to exemplary embodiments of the invention, bit slice 600 may be used with any suitable CSA tree constellation, as is known in the art. For example, bit slice 600 may be implemented as part of a DMCSA tree constellation and/or any other hardware element or circuit to perform the PP reduction functionality according to the invention. Although the invention is not limited in this respect, bit slice 600 may be used to perform the functionality of one or more of bit slices b16-b31 of FIG. 5, e.g., bit slices b20, b21, b26 and/or b27. It will be appreciated by those skilled in the art, that in some embodiments of the invention bit slice 600 may be modified in accordance with one or more specific features of a CSA tree constellation including bit slice 600. For example, one or more inputs of one or more CSA elements of bit slice 600 may be associated with a preceding bit slice of the CSA tree constellation, and/or one or more outputs of one or more CSA elements of bit slice 600 may be associated with a succeeding bit slice of the CSA tree constellation, e.g., to allow carry propagation between the bit slices as is known in the art.

Aspects of the invention are described herein in the context of an exemplary embodiment of one or more FAs, e.g., e.g., FA 650 and/or FA 652, being part of a bit slice, e.g., bit slice 600. However, it will be appreciated by those skilled in the art that, according to other embodiments of the invention, any other combination of integral or separate units may also be used to provide the desired functionality, for example, one or more of the FAs, e.g., FA 650 and/or FA 652, may be implemented as separate units or as parts of other units, e.g., output module 232 (FIG. 2).

Although some exemplary embodiments of the invention are described above with reference to a switchable 9:2/(6:2+3:2) bit slice, it will be appreciated by those skilled in the art that other embodiments of the invention include switchable bit slices including one or more switches for selectively switching between any desired two or more configurations of the bit slice, e.g., as described below.

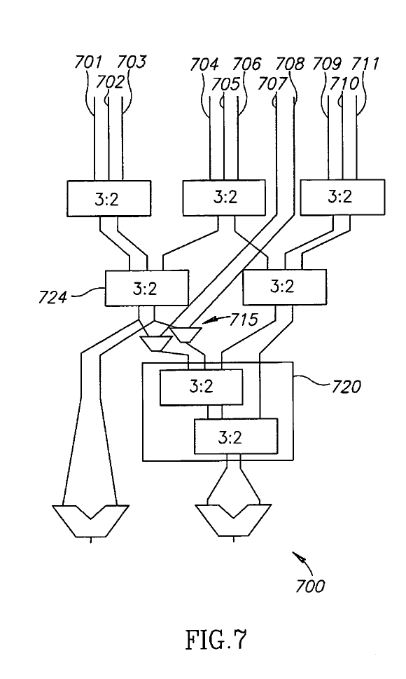

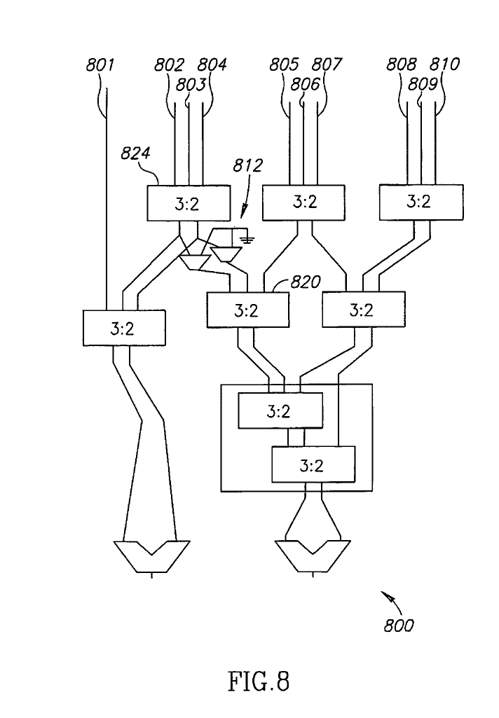

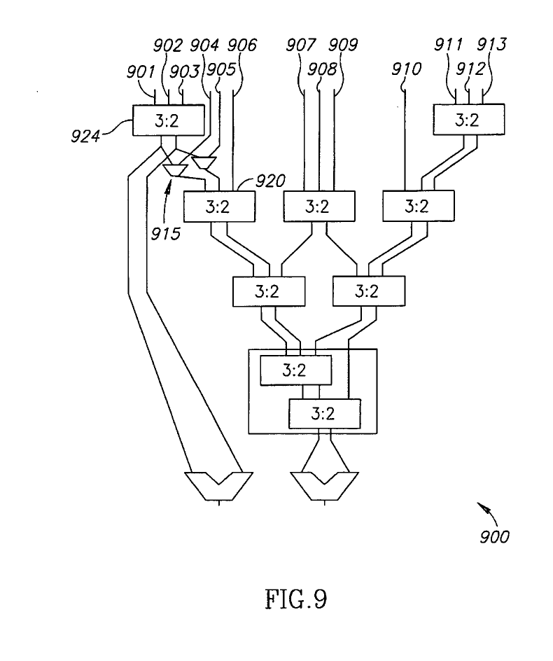

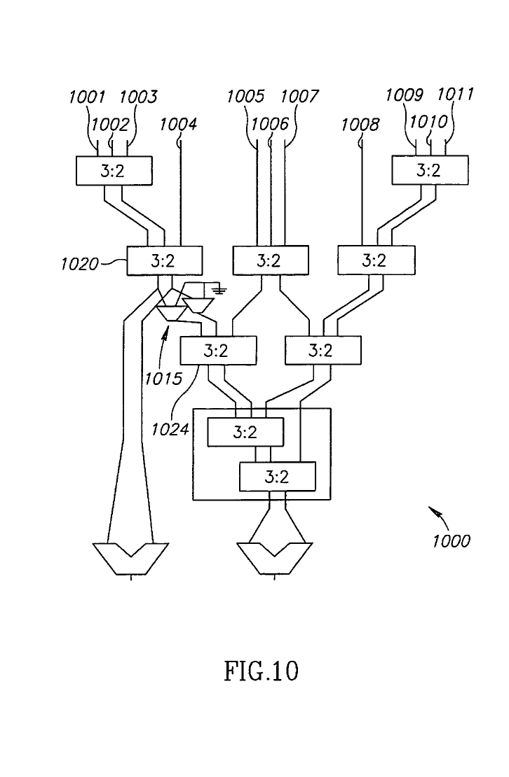

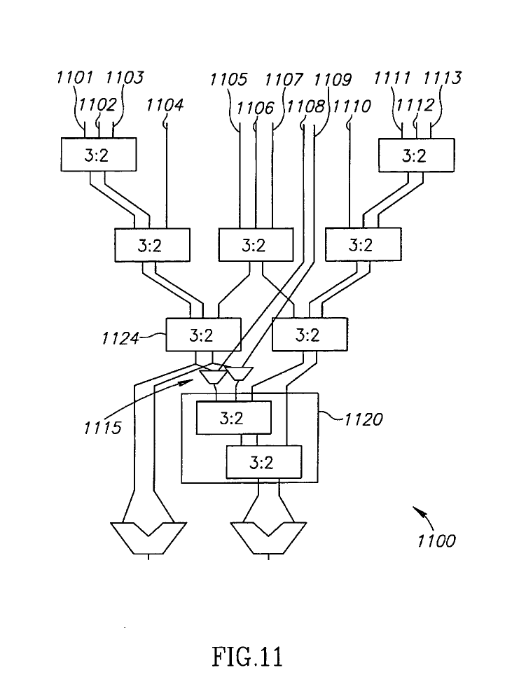

Reference is made to FIGS. 7-11, which schematically illustrate switchable bit slices 700, 800, 900, 1000, and 1100, respectively, according to exemplary embodiments of the invention.

According to exemplary embodiments of the invention, bit slice 700 may include eleven PP inputs 701-711, and a switch 715 for selectably associating two inputs of a 4:2 CSA 720 with either two outputs of a 3:2 CSA 724, e.g., in a first mode of operation; or with PP inputs 707 and 708, e.g., in a second mode of operation. Accordingly, in the first mode of operation bit slice 700 may be able reduce nine PPs provided to inputs 701-706 and 709-711. In the second mode of operation, bit slice 700 may be able to separately reduce four PPs provided to inputs 701-704 and five PPs provided to inputs 707-711.

According to exemplary embodiments of the invention, bit slice 800 may include ten PP inputs 801-810, and a switch 812 for selectably associating two inputs of a first 3:2 CSA 820 with either two outputs of a second 3:2 CSA 824, e.g., in a first mode of operation, or with two zero inputs, e.g., in a second mode of operation. Accordingly, in the first mode of operation bit slice 800 may be able reduce nine PPs provided to inputs 802-810. In the second mode of operation, bit slice 800 may be able to separately reduce four PPs provided to inputs 801-804 and six PPs provided to inputs 805-810. Alternatively, in the second mode of operation two additional PPs may be respectively provided to the two inputs of switch 812, e.g., instead of the two zero inputs. Accordingly, in the second mode of operation, bit slice 800 may be able to separately reduce four PPs and eight PPs.

According to exemplary embodiments of the invention, bit slice 900 may include thirteen PP inputs 901-913, and a switch 915 for selectably associating two inputs of a first 3:2 CSA 920 with either two outputs of a second 3:2 CSA 924, e.g., in a first mode of operation, or with inputs 905 and 906, e.g., in a second mode of operation. Accordingly, in the first mode of operation bit slice 900 may be able reduce eleven PPs provided to inputs 901-903 and 906-913. In the second mode of operation, bit slice 900 may be able to separately reduce three PPs provided to inputs 901-903 and ten PPs provided to inputs 904-913.

According to exemplary embodiments of the invention, bit slice 1000 may include eleven PP inputs 1001-1111, and a switch 1015 for selectably associating two inputs of a first 3:2 CSA 1020 with either two outputs of a second 3:2 CSA 1024, e.g., in a first mode of operation, or with two zero inputs, e.g., in a second mode of operation. Accordingly, in the first mode of operation bit slice 1000 may be able reduce eleven PPs provided to inputs 1001-1011. In the second mode of operation, bit slice 1000 may be able to separately reduce four PPs provided to inputs 1001-1004 and seven PPs provided to inputs 1005-1011. Alternatively, in the second mode of operation two additional PPs may be respectively provided to the two inputs of switch 1015, e.g., instead of the two zero inputs. Accordingly, in the second mode of operation, bit slice 1000 may be able to separately reduce four PPs and nine PPs.

According to exemplary embodiments of the invention, bit slice 1100 may include thirteen PP inputs 1101-1113, and a switch 1115 for selectively associating two inputs of a 4:2 CSA 1120 with either two outputs of a 3:2 CSA 1124, e.g., in a first mode of operation, or with inputs 1109 and 1110, e.g., in a second mode of operation. Accordingly, in the first mode of operation bit slice 1100 may be able reduce eleven PPs provided to inputs 1101-1107 and 1110-1113. In the second mode of operation, bit slice 1100 may be able to separately reduce five PPs provided to inputs 1101-1105 and six PPs provided to inputs 1108-1013.

It will be appreciated by those skilled in the art, that other embodiments of the invention may include other switchable bit slices having any desired configuration adapted for reducing a first set of one or more PPS and a second set of one or more PPs separately from one another. For example, some embodiments of the invention may include bit slices having a 18:2 carry-save-adder tree configuration, a 19:2 carry-save-adder tree configuration, or a 22:2 carry-save-adder configuration, e.g., in the first or second mode of operation.

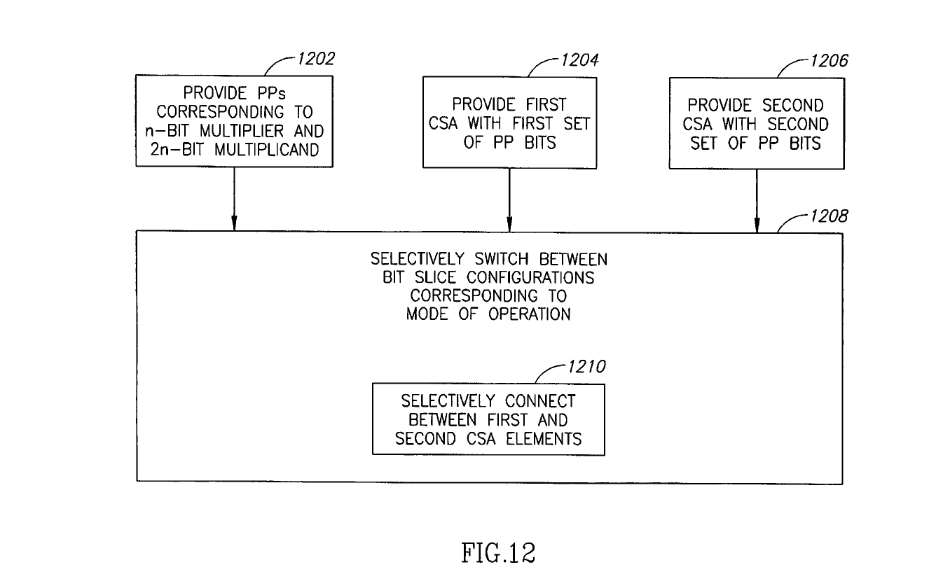

Reference is made to FIG. 12, which schematically illustrates a method of switching between bit-slice configurations according to some exemplary embodiments of the invention.

As indicated at block 1208, the method may include selectively switching between at least first and second configurations of a carry-save-adder bit slice, e.g., bit slice 600 (FIG. 6) corresponding to at least first and second modes of operation of the bit slice, e.g., as described above.

As indicated at block 1210, switching between the at least first and second configurations may include selectably connecting between first and second carry-save-adder elements of the bit slice, e.g., as described above with reference to FIG. 6.

As indicated at block 1202, the method may also include providing the bit slice with a plurality of partial products corresponding to a multiplication of an n-bit multiplier operand and a 2n-bit multiplicand operand when the bit slice is in the second mode of operation, e.g., as described above.

As indicated at blocks 1204 and/or 1206 the method may also include providing a first carry-save-adder tree of the second configuration with a first set of partial product bits corresponding to a multiplication of a first n-bit multiplier operand and a first n-bit multiplicand operand, and/or providing a second carry-save-adder tree of the second configuration with a second set of partial product bits corresponding to a multiplication of a second n-bit multiplier operand and a second n-bit multiplicand operand, e.g., at the second mode of operation.

It will be appreciated by those skilled in the art that a multiplier according to exemplary embodiments of the invention, e.g., multiplier 200 (FIG. 2), may be able to selectively perform a multiplication of a 2n-bit multiplier operand and a 2n-bit multiplicand operand, or four multiplications of four n-bit multiplier operands and four n-bit multiplicand operands, and may have a capacity of less than (3n bits)*(2n bits), for example, a capacity of substantially (2n bits)*(2n bits). For example, the multiplier according to embodiments of the invention, e.g., multiplier 200 (FIG. 2) may be able to selectively perform either one of a multiplication of 32-bit multiplier and multiplicand operands, or four multiplications of for 16-bit multiplier and multiplicand operands, and may have a capacity of less than 48 bits*32 bits, e.g., a capacity of substantially 32bits*32 bits.

It will also be appreciated by those skilled in the art that a multiplier according to other exemplary embodiments of the invention may include a multiplier configuration, e.g., including PP module 208 and DMCSA 212, able to selectively perform a multiplication of an n-bit multiplier operand and a 2n-bit multiplicand operand, or two multiplications of two n-bit multiplier operands and two n-bit multiplicand operands, and may have a capacity of less than 3n bits*n bits, for example, a capacity of substantially 2n bits*n bits.

Embodiments of the present invention may be implemented by software, by hardware, or by any combination of software and/or hardware as may be suitable for specific applications or in accordance with specific design requirements. Embodiments of the present invention may include units and sub-units, which may be separate of each other or combined together, in whole or in part, and may be implemented using specific, multi-purpose or general processors, or devices as are known in the art. Some embodiments of the present invention may include buffers, registers, storage units and/or memory units, for temporary or long-term storage of data and/or in order to facilitate the operation of a specific embodiment.

While certain features of the invention have been illustrated and described herein, many modifications, substitutions, changes, and equivalents may occur to those of ordinary skill in the art. It is, therefore, to be understood that the appended claims are intended to cover all such modifications and changes as fall within the true spirit of the invention.

1. An apparatus comprising:
one or more switches able to selectively switch between at least first and second configurations of a carry-save-adder bit slice corresponding to at least first and second respective modes of operation of said bit slice.

2. The apparatus of claim 1, wherein at least one of said one or more switches are able to selectably associate between first and second elements of said bit slice.

3. The apparatus of claim 2, wherein said first and second elements comprise carry-save-adder elements of two different stages of said bit slice.

4. The apparatus of claim 2, wherein at least one of said switches comprises a multiplexer having an input connected to said first carry-save-adder element and an output connected to said second carry-save adder element.

5. The apparatus of claim 4, wherein said multiplexer has an additional input receiving a zero value.

6. The apparatus of claim 4, wherein said multiplexer has an additional input able to receive a partial product bit.

7. The apparatus of claim 2, wherein one or both of said first and second carry-save adder elements comprise either one of a 3 to 2 carry-save adder and a 4 to 2 carry-save-adder.

8. The apparatus of claim 1, wherein said first configuration comprises a reduction arrangement able to produce an output corresponding to a product of an n-bit multiplier operand and a 2n-bit multiplicand operand.

9. The apparatus of claim 8, wherein said reduction arrangement comprises a carry-save-adder tree configuration selected from the group consisting of a 9 to 2 carry-save-adder tree configuration, a 11 to 2 carry-save-adder tree configuration, a 12 to 2 carry-save-adder tree configuration, a 18 to 2 carry-save-adder tree configuration, a 19 to 2 carry-save-adder tree configuration, and a 22 to 2 carry-save-adder tree configuration.

10. The apparatus of claim 1, wherein said second configuration comprises first and second, separate, reduction arrangements.

11. The apparatus of claim 10, wherein said first and second reduction arrangements are able to produce two outputs corresponding to two products of two n-bit multiplier operands and two n-bit multiplicand operands, respectively.

12. The apparatus of claim 10, wherein said first reduction arrangement comprises a 6 to 2 carry-save-adder tree configuration and said second carry-save-adder tree comprises a 3 to 2 carry-save-adder tree configuration.

13. The apparatus of claim 10, wherein said first carry-save-adder tree comprises a 5 to 2 carry-save-adder tree configuration and said second carry-save-adder tree comprises a 4 to 2 carry-save-adder tree configuration.

14. A method comprising:
selectively switching between at least first and second configurations of a carry-save-adder bit slice corresponding to at least first and second respective modes of operation of said bit slice.

15. The method of claim 14, wherein said switching comprises selectably connecting between first and second carry-save-adder elements of said bit slice.

16. The method of claim 14 comprising providing said bit slice when said bit slice is in said first mode of operation with a plurality of partial products corresponding to a multiplication of an n-bit multiplier operand and a 2n-bit multiplicand operand.

17. The method of claim 14, wherein said second configuration comprises first and second, separate, carry-save-adder trees, said method comprising:
providing said first carry-save-adder tree with a first set of partial product bits corresponding to a multiplication of a first n-bit multiplier operand and a first n-bit multiplicand operand; and
providing said second carry-save-adder tree with a second set of partial product bits corresponding to a multiplication of a second n-bit multiplier operand and a second n-bit multiplicand operand.

18. A processor comprising:
a multiplier having a capacity of less than (3n bits)*(n bits) and able to selectively either multiply an n-bit multiplier operand and a 2n-bit multiplicand operand, or multiply two n-bit multiplier operands and two n-bit multiplicand operands, respectively.

19. The processor of claim 18, wherein said multiplier has a capacity of substantially (2n bits)*(n bits).

20. The processor of claim 18, wherein said multiplier comprises a carry-save-adder-tree constellation having first and second modes of operation and including one or more switches able to selectively switch between at least first and second configurations of one or more bit slices of said carry-save-adder tree constellation corresponding to said first and second modes of operation, respectively.

21. The processor of claim 20, wherein at least one of said switches comprises a multiplexer having an input connected to a first carry-save-adder element of said bit slice and an output connected to a second carry-save adder element of said bit slice.

22. The processor of claim 20, wherein said first configuration comprises a reduction arrangement able to produce an output corresponding to a product of said n-bit multiplier operand and said 2n-bit multiplicand operand.

23. The processor of claim 20, wherein said second configuration comprises first and second, separate, reduction arrangements.

24. The processor of claim 23, wherein said first and second reduction arrangements are able to produce two outputs corresponding to two products of said two n-bit multiplier operands and said two n-bit multiplicand operands, respectively.

25. A computing platform comprising:
a memory; and
a processor associated with said memory and including one or more switches able to selectively switch between at least first and second configurations of a carry-save-adder bit slice according to at least first and second modes of operation of said bit slice.

26. The computing platform of claim 25, wherein said first configuration comprises a reduction arrangement able to produce an output corresponding to a product of an n-bit multiplier operand and a 2n-bit multiplicand operand.

27. The computing platform of claim 25, wherein said second configuration comprises first and second, separate, reduction arrangements.

28. The computing platform of claim 27, wherein said first and second reduction arrangements are able to produce two outputs corresponding to two products of two n-bit multiplier operands and two n-bit multiplicand operands, respectively.

29. A computing platform comprising:
a memory; and
a processor associated with said memory and including a multiplier able to selectively either multiply an n-bit multiplier operand and a 2n-bit multiplicand operand, or multiply two n-bit multiplier operands and two n-bit multiplicand operands, respectively, wherein said multiplier has a capacity of less than (3n bits)*(n bits).

30. The computing platform of claim 29, wherein said multiplier has a capacity of substantially (2n bits)*(n bits).

31. The computing platform of claim 29, wherein said multiplier comprises a carry-save-adder-tree constellation having first and second modes of operation and including one or more switches able to selectively switch between at least first and second configurations of one or more bit slices of said carry-save-adder tree constellation corresponding to said first and second modes of operation, respectively.

32. The computing platform of claim 31, wherein said first configuration comprises a reduction arrangement able to produce an output corresponding to a product of said n-bit multiplier operand and said 2n-bit multiplicand operand.

33. The computing platform of claim 31, wherein said second configuration comprises first and second, separate, reduction arrangements able to produce two outputs corresponding to two products of said two n-bit multiplier operands and said two n-bit multiplicand operands, respectively.
